(19) United States
(12) Patent Application Publication
(10) Pub. No.: US 2021/0174693 A1
(43) Pub. Date: Jun. 10, 2021

(54) AN INTERFACE FOR TRAINING CONTENT OVER A NETWORK OF MOBILE DEVICES

(71) Applicant: BITES LEARNING LTD., Te! Aviv-Yafo (IL)

(72) Inventors: Tal ALMOG NAGLER, Tel Aviv (IL); Hagai CHOROWICZ, Bney-Tziyon (IL)

(73) Assignee: BITES LEARNING LTD., Te! Aviv-Yafo (IL)

(21) Appl. No.: 16/761,501

(22) PCT Filed: Nov. 21, 2018
(86) PCT No.: PCT/IL2018/051262

§ 371 Date: May 5, 2020

Related U.S. Application Data
(60) Provisional application No. 62/590,290, filed on Nov. 23, 2017.

(51) Int. Cl. G09B 7/07; G09B 7/02; G09B 5/12; G09B 5/06; H04L 12/58

(52) U.S. Cl. CPC G09B 7/07; G09B 7/02; H04L 51/32; G09B 5/065; G09B 5/125

(57) ABSTRACT

In some embodiments there is disclosed interface for controlling the distribution of content over a network of mobile devices. Optionally teaching content produced on a mobile network device is distributed using a central server. Optionally, an overseer interface facilitates monitoring of the content and/or its distribution. In some embodiments, the system includes tools for an overseer to follow and/or control the distribution of the material over a network and/or consequential discussion. In some embodiments, there is disclosed an interface for producing the content. For example, the interface may enforce a strict format that facilitates quick production of a lesson and/or acquiring of knowledge using a mobile network device. The format is optionally configured to encourage retention of information and/or further sharing.

### RELATED APPLICATION/S

This application claims the benefit of priority under 35 USC § 119(e) of U.S. Provisional Patent Application No. 62/590,290 filed 23 Nov. 2017, the contents of which are incorporated herein by reference in their entirety.

### FIELD OF THE INVENTION

The present invention, in some embodiments thereof, relates to an interface for training content and more particularly but not exclusively to an interface for use on a mobile network communication device.

### BACKGROUND OF THE INVENTION

International published patent application no. 2004059593 appears to disclose “a learning system which is pedagogically and psychologically efficient and permits students to manage the way and timing of their educational progress, comprising the degree of knowledge from which he starts and the degree of knowledge that he wishes to attain. The system of the invention does not require the presence or the collaboration of an instructor in real time, although such a presence is possible in this invention and may be desirable in certain cases, nor does it comprise or require equipment other than a personal communication means, typically a cellular phone, of the student, server systems that are readily available, and conventional connection means.”

U.S. Pat. No. 8,560,366 appears to disclose, “A system, method, and article of manufacture are provided for technology sharing during demand and supply planning in a network-based supply chain environment. Steps included are providing locator and mapping capabilities utilizing the network. Technology that includes streaming audio, stereo audio and video data is also shared utilizing the network. Encryption capabilities for the technology are also included. Further, searching capabilities are provided utilizing the network in addition to logging events and passive user profiling. The event logging includes logging network operations. User profile data is automatically received and stored. User profile data includes user identity, state, preferences and interests. User profile data is also automatically exported to an active profile manager which automatically adds additional user profile data. Additional user profile data includes information related to whether the user is a service provider or a manufacturer and the location of user.”

### SUMMARY OF THE INVENTION

The present invention successfully addresses the shortcomings of the presently known instructor tools by providing a simple to use, intuitive multimedia tool for packaging together interactive, multimedia presentations in a quick and easy manner.

According to an aspect of some embodiments of the invention, there is provided an interface for distributing an educational content over a network including: instructions stored on a computer readable medium accessible to a mobile device of an instructor for packaging a educational content item and at least one questions into a lesson; storing the lesson on a server connected over the network to a plurality of student devices; sending a link to the plurality of student devices over a social network for accessing the educational content item from the server; instructions stored on a computer readable medium accessible to the server for sending the educational content item to each device of the plurality of student device over the network in response to accessing the link by the each device and storing information about the sending; further sending the at least one question to each device the plurality of student device over the network on demand from the each device after the accessing the link by the each device and storing information about the further sending; receiving a plurality of responses to the at least one question from the plurality of student devices; reporting the information on the sending and the information on the further sending and information of the plurality of responses to the instructor device over the network.

According to some embodiments of the invention, the interface further includes instructions stored on a computer readable medium accessible to the server for storing the plurality of responses.

According to some embodiments of the invention, the interface further includes a template stored on a computer readable medium accessible to the instructor device, the template including instructions for recording the at least one question in audio format using a microphone of the instructor device.

According to some embodiments of the invention, the interface where the interface includes instructions for limiting the questions to less than 2 minutes.

According to some embodiments of the invention, the interface further includes a template stored on a computer readable medium accessible to the instructor device, the template including instructions for recording the at least one question using a text input interface of the instructor device.

According to some embodiments of the invention, the interface where the interface includes instructions for limiting the questions to less than 500 characters.

According to some embodiments of the invention, the interface further includes a template stored on a computer readable medium accessible to the instructor device, the template including instructions for recording a narration for at least one of a picture and a video in the education content.

According to some embodiments of the invention, the interface where the interface includes instructions for limiting the narration to less than 2 minutes.

According to some embodiments of the invention, the narration is in audio format and the instructions of recording a includes instructions for recording the narration over a microphone of the instructor device.

According to some embodiments of the invention, the narration is in a text format and the instructions of recording a includes instructions for recording the narration using a textual input interface of the instructor device.

According to some embodiments of the invention, the interface where the interface includes instructions for limiting the narration to less than 500 characters.

According to some embodiments of the invention, the interface further includes a template stored on a computer readable medium accessible to the instructor device, the template including instructions for recording the education content in audio format using a microphone of the instructor device.

According to some embodiments of the invention, the interface where the interface includes instructions for limiting the questions to less than 10 minutes.

According to some embodiments of the invention, the interface further includes a template stored on a computer readable medium accessible to the instructor device, the template including instructions for recording the educational content using a text input interface of the instructor device.

According to some embodiments of the invention, the interface where the interface includes instructions for limiting the education content to less than 2000 characters.

According to some embodiments of the invention, the interface further includes instructions for producing a group including the plurality of students devices and the instructor device for discussion of the educational content and for sharing the discussion with the group.

According to some embodiments of the invention, the sharing is over the social network.

According to some embodiments of the invention, the sharing is over the network.

According to some embodiments of the invention, the sharing is via the server.

According to some embodiments of the invention, the interface further includes instructions to include a mediator in the group.

According to some embodiments of the invention, the interface further includes instructions for directing the discussion to the server and the server includes memory for storing the discussion.

According to an aspect of some embodiments of the invention, there is provided a method of distributing an educational content item over a network including: packaging a educational content item and at least one questions into a lesson; storing the lesson on a server connected over the network to a plurality of student devices; sending a link to the plurality of student devices over a social network for accessing the educational content item from the server; sending the educational content item to each device of the plurality of student device over the network in response to accessing the link by the each device and storing information about the sending; further sending the at least one question to each device the plurality of student device over the network on demand from the each device after the accessing the link by the each device and storing information about the further sending; receiving a plurality of responses to the at least one question from the plurality of student devices; and reporting the information on the sending and the information on the further sending and information of the plurality of responses to an instructor device over the network.

According to some embodiments of the invention, the method further includes storing the plurality of responses on the server.

According to some embodiments of the invention, the method further includes recording the at least one question in audio format using a microphone of the instructor device.

According to some embodiments of the invention, the method further includes limiting the questions to less than 2 minutes.

According to some embodiments of the invention, the method further includes recording the at least one question using a text input interface of the instructor device.

According to some embodiments of the invention, the method further includes limiting the questions to less than 500 characters.

According to some embodiments of the invention, the method further includes recording a narration for at least one of a picture and a video in the education content.

According to some embodiments of the invention, the method further includes limiting the narration to less than 2 minutes.

According to some embodiments of the invention, the narration is in audio format and the instructions of recording a includes instructions for recording the narration over a microphone of the instructor device.

According to some embodiments of the invention, the narration is in a text format and further including recording the narration using a textual input interface of the instructor device.

According to some embodiments of the invention, the method further includes recording the education content in audio format using a microphone of the instructor device.

According to an aspect of some embodiments of the invention, there is provided a system for overseeing distribution of a teaching content over a network: a plurality of learner devices connected to the network and subscribed to a social network; a server connected to the network, the server including a memory for storing a packaged lesson, distribution information and response data; a processor configured for sending the educational content item to each device of the plurality of student device over the network in response to accessing the link by the each device and storing information about the sending; further sending the at least one question to each device the plurality of student device over the network on demand from the each device after the accessing the link by the each device and storing information about the further sending; receiving a plurality of responses to the at least one question from the plurality of student devices; reporting the information on the sending and the information on the further sending and information of the plurality of responses to an instructor device over the network; an instructor device configured for, packaging a educational content item and at least one questions into a lesson; storing the lesson on a server connected over the network to a plurality of student devices; sending a link to the plurality of student devices over a social network for accessing the educational content item from the server.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer, and may not be feasible or practical for performing purely manually, by a human expert. A human expert who wanted to manually perform similar tasks might be expected to use completely different methods, e.g., making use of expert knowledge and/or the pattern recognition capabilities of the human brain, which would be vastly more efficient than manually going through the steps of the methods described herein.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B illustrate systems for distribution of content in accordance with embodiments of the current invention;

FIG. 2 illustrates method to produce and/or package and/or share a lesson in accordance with an embodiment of the current invention;

FIG. 3A-3E are screen shot illustrations of an interface to generate, package and/or share a lesson in accordance with an embodiment of the current invention;

FIG. 4 illustrates method to learn a lesson in accordance with an embodiment of the current invention; and

FIGS. 5A-5F illustrates method to produce and/or package and/or share a lesson in accordance with an embodiment of the current invention.

### DESCRIPTION OF THE PREFERRED EMBODIMENTS

The present invention, in some embodiments thereof, relates to a multimedia tool and, more particularly, to a tool for amalgamating various media into an interactive media presentation.

### Overview

An aspect of some embodiments of the current invention relates to an interface for controlling the distribution of content over a network of mobile devices. Optionally training content produced on a mobile network device is distributed using a central server. Optionally, an overseer interface facilitates monitoring of the content and/or its distribution. In some embodiments, the system includes tools for an overseer to follow and/or control the distribution of the material over a network and/or consequential discussion.

An aspect of some embodiments of the present invention relates to an interface for sharing knowledge over a network. In some embodiments, the interface enforces a strict format that facilitates quick production of a lesson and/or acquiring of knowledge using a mobile network device. The format is optionally configured to encourage retention of information and/or further sharing.

In some embodiments, an application is supplied for a member of a group (for example a commercial organization), a content producer (an instructor), to produce an interactive content item and/or share it over a network (for example a social network) with a group of learners. The application optionally automatically stores the content on a network accessible server. When a learner views and/or responds to the content, a record of what was viewed and/or the response is saved. Optionally, the content and/or the responses are made available to various users, e.g. the content producer, some or all of the learners and/or an overseer. For example, a user may get level of detail available may depend on the user privileges. For example, a user may get access to public contents (e.g. shared over the network) and/or statistics about learners and/or responses

The present invention discloses an innovative tool for creating, sharing and overseeing distribution a digital unit of content. Content creation may include packaging together various digital media using only the basic features of a smartphone or tablet. The instructor records and/or gathers the base materials and the application renders them into a single digital unit or package which includes design, question and answer survey as well as a chat or forum option to facilitate discussion between students regarding the study material.

In some embodiments, the digital unit encompasses the entire teaching cycle within the unit. Optionally, the micro-lesson is not merely a teaching aid but rather a substantially self-contained learning experience. The teaching cycle includes, for example: delivery of knowledge, application of the knowledge via questioning, debriefing and/or feedback facilitated through the presentation of the solution by the instructor and group learning over a network and/or discussion over a network facilitated by a chat feature and/or forum.

Innovatively, embodiments of the immediate system make the digital world available to the instructor for him or her to create digital micro-lessons. The otherwise complicated and time-consuming task that would take many hours of use over various different software applications (many of which demand a high degree of knowledge and experience in order to produce a quality result), may be made available to one of average skill in the computer arts by a few simple clicks and touches on the touch screen of the ubiquitous smartphone. In some embodiments, even those users with only the most basic capabilities on the smartphone are now able to produce extremely high quality digital micro-lessons which are very effective teaching tools. The accessibility afforded by embodiments of the immediate system facilitates the instructor reaching students, communicating with the students and/or creating digital material that the teacher may otherwise not be able to create.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

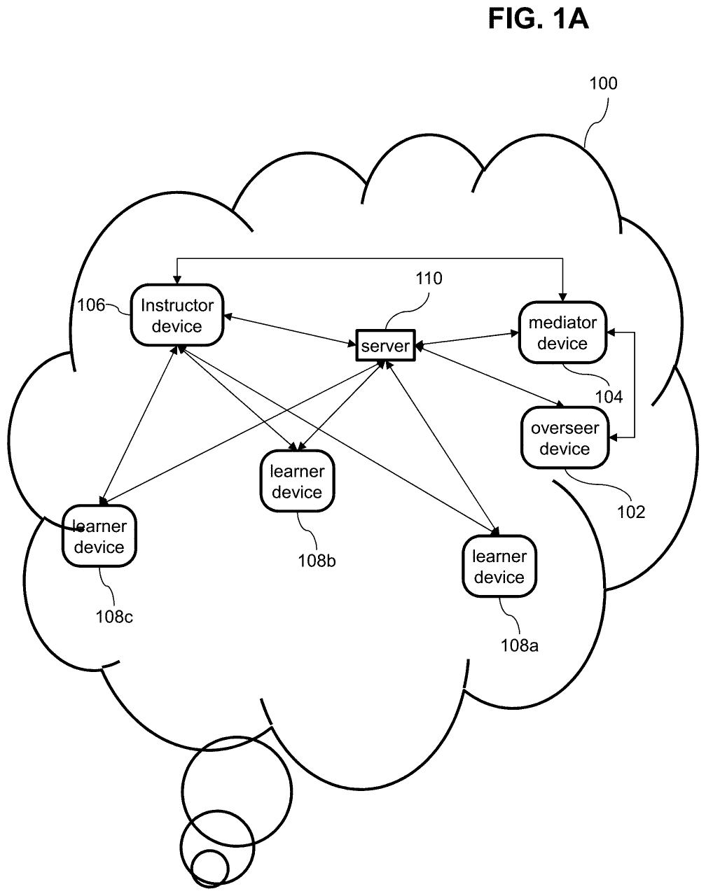

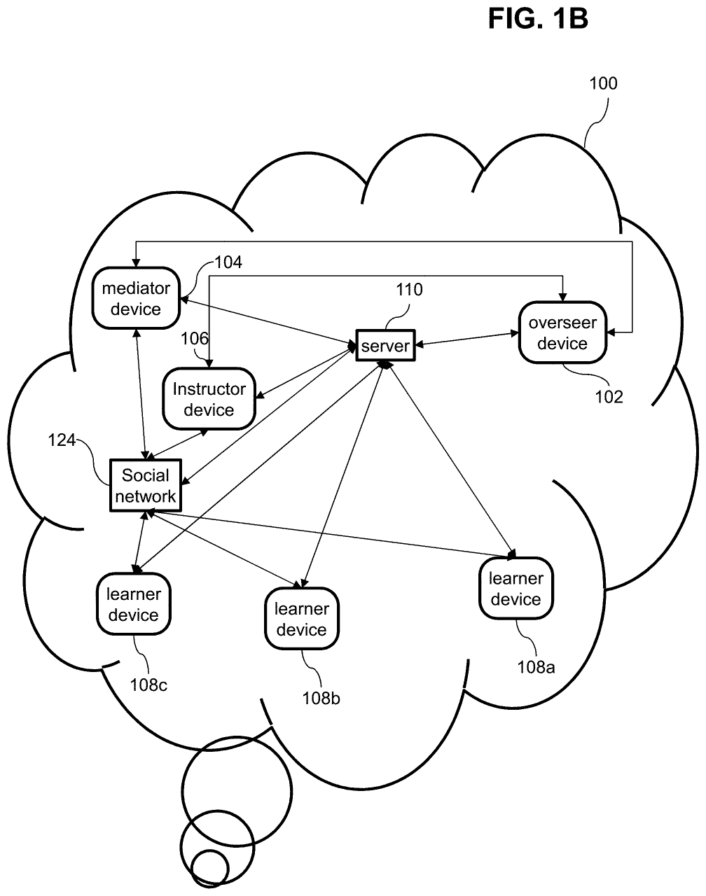

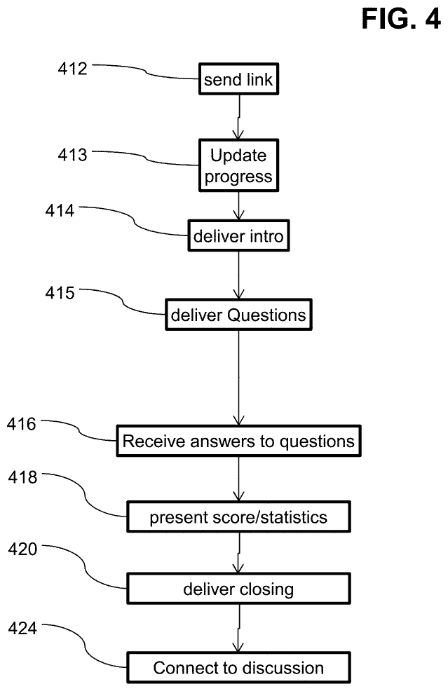

FIGS. 1A and 1B illustrate systems for distribution of content in accordance with embodiments of the current invention. In some embodiments, a network 100 provide connects a plurality of user communication devices including for example a device 102 associated with an overseer and/or a mediator device 104 and/or an instructor device 106 (for example device 406 as illustrated in FIGS. 4A-4E) and/or a learner device 108a, 108b, 108c. Optionally, a server 110 is also connected to the network and/or supplies continuous access to content. Each device 102, 104, 106 and/or 108a-108c optionally includes a processor, read write accessible memory, a camera, a microphone, a speaker, a view screen and/or a text input interface.

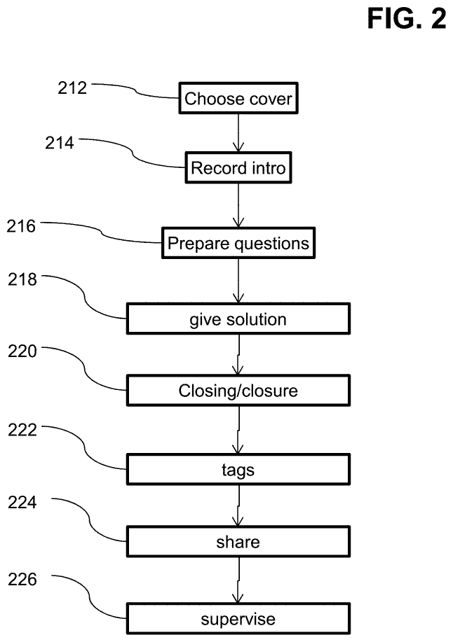

In some embodiments, the instructor device includes a lesson packaging interface. Optionally the lesson packaging interface include software directing an instructor in production and distribution of a lesson package (for example as illustrated in FIG. 2). Optionally the interface receives materials from the instructor and packages them as a lesson. The interface then receives sharing instructions from the instructor. For example, sharing instructions may include an identity of a group of learners. The interface optionally uploads the lesson package to server 110 and/or sends links to the stored package, for example over a social network 124, to learner devices 108a-108c. The interface may further form a group on the social network 124 including the learners' and server 110. For example, further communication related to the lesson will be shared with the learners and the instructor and/or stored on server 110. Server 110 optionally makes materials, communications and/or statistics about the interactions available to the moderator and/or the overseer over the same social network 124 as the learners and/or via a different interface (for example the overseer may have an overseeing application that communicates directly with server 110 over network 100).

In accordance with some embodiments of the current invention, a system (for example as illustrated in FIG. 1A and/or FIG. 1B) may be used for marketing communication. For example, an instructional bite may include advertising content and/or customer instructions and/or a user survey. Optionally, data may be tracked on users of the bite (e.g. who reads, to with whom do they share, what are their comments, what are their response). For example, an interesting introductory video may go viral and carry with it a survey to learn about the understanding and/or needs of potential customers. Alternatively or additionally, the bite may be sent to a large population and/or bring connections to people who might be interested in products etc.

FIG. 2 illustrates method to produce and/or package and/or share a communication bite in accordance with an embodiment of the current invention. For example, the instructor may supply content including media and/or text for teaching and review of a lesson. For example, the instructor may interactively record content and/or upload. The interface may package the content and further query to the instructor to select a social network over which to share the lesson and/or a group of learners with whom to share the lesson. The interface may send the package to a server and/or share links to the server to the group over the network.

In some embodiments, a multimedia packaging tool uses the basic functionality of the mobile device including for example some or all of video, camera, gallery, voice recordings, sound files, sharing Internet content. Optionally, the system gives the instructor a tool to create a lesson that covers the entire cycle of learning. For example, the system may guide the user to produce a lesson in a micro-lesson digital unit. Optionally, the tool guides the user to produce the lesson quickly and/or efficiently for example by constraining the creation process to inhibit wasteful practices.

In some embodiments, a system will supply one or more fixed formats for a digital communication (or “Bite”). For example, an instructor will open a dedicated application on his device and/or will open a lesson preparation interface via a general program (such as a browser and/or an editor). Optionally, the system will query the user for content. For example, the content will be narrowly defined and/or limited.

In some embodiments the interface will query the instructor for a cover 212 for the lesson. Optionally, the cover 212 will have a standard form that will open when the learner clicks on a link the lesson. For example, the cover 212 may include information telling the learner who thinks that he needs to know this information and some idea of what it is. The cover 212 optionally also includes a start control and/or an identifiable form (for example, a graphic making it easier to recall the identity and/or content of the bite and/or to find the bite later. For example, inputting information for the cover is optionally limited to a few lines of text (less than 60 words) and/or choosing from a small library (of less than 200) colors and/or graphics. Optionally, the interface will inhibit instructors from spending a long-time fine tuning the cover page of their lesson. Optionally, the time for preparing a cover 212 will be on the average less than 3 minutes. Optionally, the system will time out if the user spends too much time on a task, such as the cover 212.

In some embodiments, the content of a digital unit (or “Bite”) opens with a presentation of content in an introduction 214. The introduction 214 is optionally followed by an interactive portion (for example a question 216 and/or game element). Optionally a solution 218 is provided by the instructor. The solution 218 helps motivate the learner and/or helps him evaluate his understanding of the content. Optionally, the bite closes with a closing 220 and/or a forum for discussion. Not every component has to be in every unit. For example, the instructor may decide which elements are in each Bite. Some units will have more elements and some less—depending on how the instructor structures the individual micro-lesson unit. Optionally the instructor supplies tags 222 for example for indexing the bite and/or for later reference. Once the bite is ready the interface queries the instructor for instructions how the bite is to be shared 224. Sharing may include sending out a link over a social network and/or announcing the bite on a bulletin board or the like.

In some embodiments, an element of the bite may include a picture/recording/voice/video/typing/copy-paste from texts etc. The interface optionally includes basic editing tools for video, voice over, images, text and voice. The interface is optionally tailored for an instructor's device. For example, supplying content may be done using a chain of simple menus on a small format device. Content may be supplied from network links and/or interactively using the input interface of the device (for example touch screen, microphone and/or camera). Text is optionally limited to an amount the can easily be read on a small format device. For example, text on the cover 212 in questions 216 and/or in answers may be limited to less 300 characters and/or less than 1000 characters. Content for reading may be limited to 1000 characters and/or 5000 characters and/or 10000 characters. The questions 216 can be in various forms for example multiple choice questions and/or open questions and the like. The type of question that is selected will influence the type of results that will be received as well as the manner in which the questions will be generated. The questions are optionally generated in a way that allows the instructor to indicate the correct answer.

In some embodiments, a solution 218 may include an explanatory video clip, explanation, voice clip can be provided by the instructor, according to the manner in which the question was generated. In this manner, the student who, for example, is working out math problems, may optionally receive immediate feedback indicating whether the answer is right or wrong and/or the student is optionally receives an explanation or demonstration of how the problem is supposed to be correctly solved and/or an additional understanding of his mistake that will bring him to the correct answer in the future. In some embodiments, the interface guides the instructor to prepare the questions and explanations ahead of time in a way that the student is able to enjoy a learning experience where they are challenged and then provided with immediate feedback to their response. For example, there may be an asynchronous aspect to the process from the point of view of the instructor while from the point of view of the student, the question—answer—explanation experience happens in a logical and/or instantaneous manner. In some embodiments, the lesson package over received over a network is like having a private tutor explaining the work—but without taxing the teacher to be private tutor for each student.

In some embodiments, a lesson planning interface includes a tool for adding a gaming element into the micro-lesson digital unit. For example, introducing a gaming element into the unit adds an aspect of fun to the learning experience—and in some cases, the gaming element may also be competitive. For example, the interface may facilitate Competition that is a healthy incentive for academic success. For example, the competitive element may pit students against each other for the best results. The interface facilitates proper use of competitive network games for example helping the students have a lot of fun.

In some embodiments, the interface includes a tool to facilitate collaborative learning. For example, the instructor may form a group and/or register learners via a forum and/or chat. The forum is optionally open to the students. In some embodiments, the forum is administered by the instructor, a mediator and/or an administrator from a pertinent organization (for example, if the bite concerns sales and/or is directed to the sales staff of a retail chain, an administrator of the chain may oversee the forum. Optionally the administrator may or may not also participate in the discussions. A forum may be a particularly means of discussing the subject matter and summing up the lesson at the end of the digital learning micro unit.

In some embodiments, the instructor has the option of generating a personalized design for the cover of the digital package. On the other hand, the instructor does not need to be a graphic designer or own specialized software in order to create the aesthetic aspect of the digital unit. In some embodiments, the instructor is discouraged from devoting too much resources to the cover of the bite (for example, the interface may limit input and/or offer only a limited choice of designs and/or once an instructor has supplied a cover the interface may discourage and/or prevent going back and reediting it. For example, the application may present step by step instructions and lists etc. from which the user selects the desired graphics. The system optionally renders the selections into a background for the project or unit. Optionally, the instructor selects which aspects of the unit are interactive and which are “frontal” or “read-only” (i.e. do not accept input from the user/student). Alternatively or additionally, the instructor may provide interactive media, such as an interactive video.

While the application is needed to create the digital package, the students themselves do not need to download and install the application in order to access the unit. Once the application renders the raw material into a cohesive multimedia package, the application generates a hyperlink to the package on the Web. The link can be sent to the students in any of the plethora of communication systems including social networks, email, SMS, posting on a forum etc. The student accesses the link over the Internet and the fully rendered package is presented to the student. On the other hand, a student can download and install the student application which gives the user increased functionality, better performance and an ability to manage a library of units, a game history and results.

In some embodiments, the system (application, server, web server, interface etc.) provides the instructor with a wide range of administrative tools to simply supervise 226 learning of the digital units. For example, the interface may include a tool for the instructor or another administrator to track each of the student's progress on the unit, e.g. a listing of the students with a column indicating whether the student has activated the link, begun the assignment and/or successfully completed the unit. For example, as the student downloads content and/or completes a unit, the server may register his progress. Optionally, data on the progress of each student may be stored on the server and/or pushed to the device of the instructor. Optionally the interface provides various statistical and analytical tools that facilitate the instructor to track and analyze the students' progress. For example, the system may provide a break-down graph of unit by question, which allows the instructor to see how everyone did for each question or problem. In some cases, this may be helpful, for example, clarify to an instructor what material is well understood and what material needs further instruction. Alternatively or additionally, the break-down can, exemplarily, be per student, showing which students did the best and which need additional instruction.

In some embodiments, the supervising may include moderating and/or monitoring the student forum for the specific unit. Where applicable the monitor can comment, respond to queries and/or monitor the communications for inappropriate behavior (i.e. just as the instructor would do in a classroom setting).

In some embodiments, an instructor has access to a personal library of a unit and in some cases to a general library (e.g. a library of English Literature digital units, such as a digital unit for chapter one of the book The Great Gatsby). The instructor is optionally, able to edit a unit that is available for personal use and/or to reuse parts of a unit. For example, this may reduce the work necessary in generating a unit.

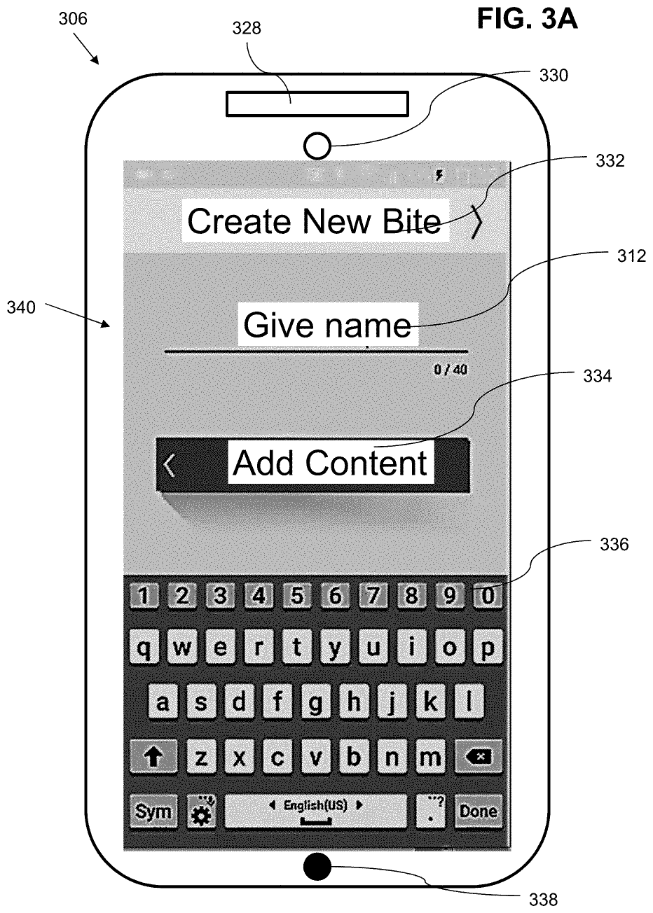

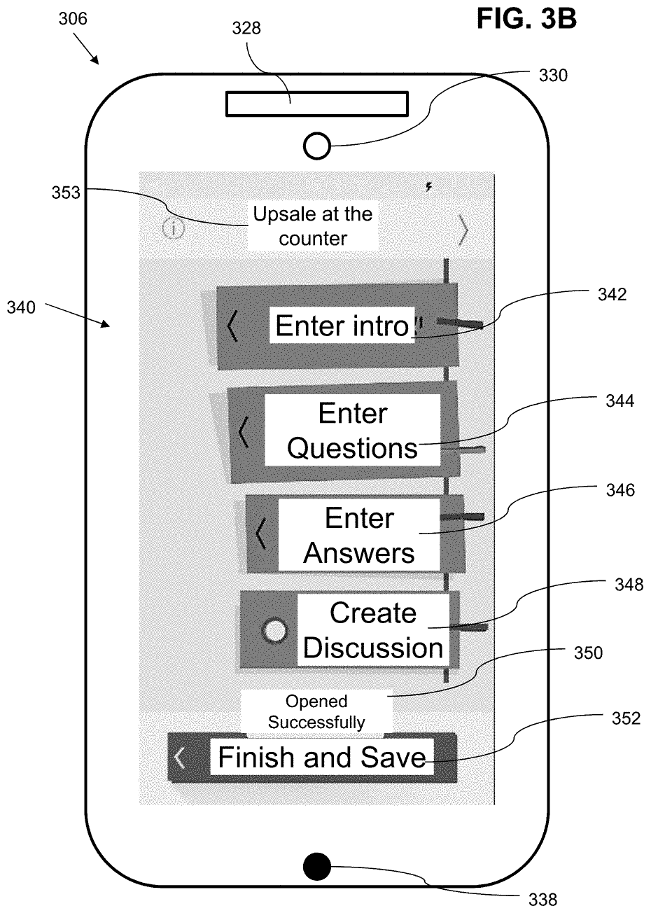

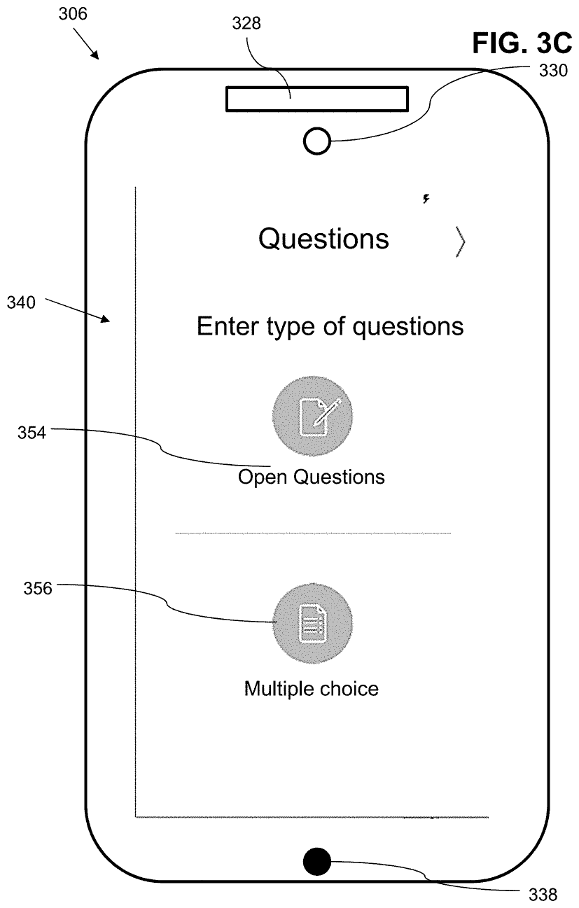

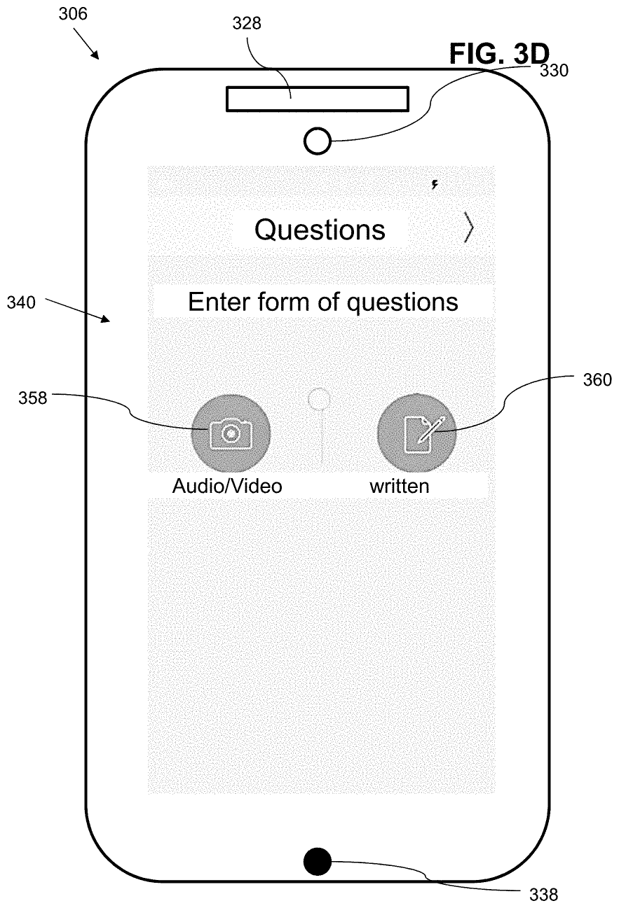

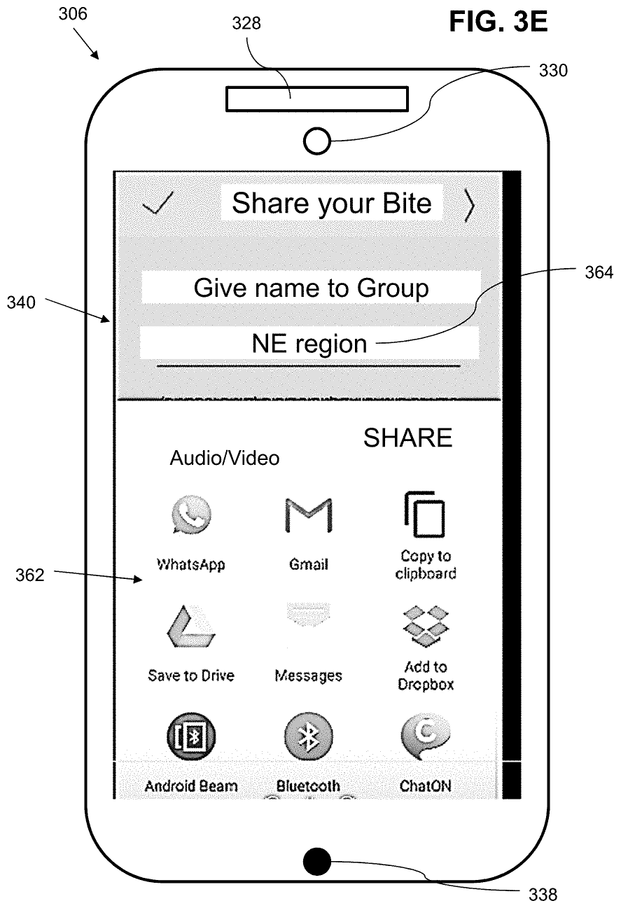

FIG. 3A-3E are screen shot illustrations of an interface to generate, package and/or share a lesson in accordance with an embodiment of the current invention. In some embodiments, the interface is configured for use on a mobile device 306. For example, the interface allows interactive input using a built-in microphone 338 to record content, questions and/or narration. For example, the interface allows use of a built-in camera 330 to make still pictures and/or video for example of content. Instructions may be passed to the instructor via audio signals from a built-in speaker 328. Alternatively or additionally, external components whether wired and/or wireless (e.g. via Bluetooth) may be used in place of speaker 328 and/or microphone 338 and/or camera 330. In some embodiments, device 306. Optionally device 306 includes a touch screen 340. In some embodiments, the menus of the interface are simple for example in order to allow viewing of the menu simultaneously with a keyboard 336 on a hand-held device 306.

FIG. 3A illustrates a menu for naming a bite. For example, the instructor may be queried for a name 312 of the Bite. Optionally the length of the name 312 may be limited (for example to less than 40 characters and/or less than 80 characters). The menu optionally includes a back button 332 (e.g. for returning to the beginning of bite creation) and/or a forward button 334 (e.g. for moving forward to adding content e.g. the introductory material) to the lesson. Optionally another menu allows the instructor to choose a background and/or foreground graphic for the cover of the bite. Optionally the chooses and format of the cover is limited. For example, having a fixed format and/or limited choices may speed up the process of preparing a lesson.

FIG. 3B illustrates a main menu of an interface for generating an instructional bite in accordance with an embodiment of the current invention. For example, an interface may facilitate making an instructional bite with 6 steps. Optionally, a first step may include naming and/or giving a cover to the bite (for example as illustrated in FIG. 3A). Optionally, a second step of adding an introduction 342 to the content may include for example a presentation of the content. For example, the introduction may be recorded interactively and/or uploaded from a local memory and/or uploaded from a network memory (e.g. cloud storage) and/or uploaded from an external source, for example a web page and/or Utube etc. Optionally, a third step may include adding interactive content (for example adding questions 344 and/or a game). Optionally, a fourth step may include providing answers to the questions 346 and/or an explanation of the correct answers and/or common mistakes. Optionally, a fifth step may include providing a closing 348. For example, the closing 348 may include a forum and/or issues for discussion 348. Alternatively or additionally, a closing 348 may include a review of the material presented in the introduction 342. Optionally a final and/or sixth step may include saving 352 the packaged bite (for example to a server) and/or sharing the bite (for example by sending links to students over a social network). Optionally a menu may include large buttons on the touch screen and/or a pop-up status notification 350 and/or an identifier 353 (for example giving information about the bite such at a title 353.

FIG. 3C illustrates a first menu for entering questions in accordance with an embodiment of the current invention. For example, to keep the menus simple for presentation on a small touch screen, the process of setting up questions may be broken into a few (e.g. less than 4 and/or between 4 to 10) steps each step having a few (e.g. less than 4 and/or between 4 to 10) choices. For example, a first menu presents a touch button for each choice of open questions 354 and/or multiple-choice questions 356. Optionally a further screen presents of choice of downloading prepared questions and/or recording questions interactively. Optionally a further screen presents choices of presenting questions in an audio, video and/or textual format the user is optionally asked how many questions there will be and/or presented a screen for recording and/or selecting each question. Optionally, menus are geared for multiple choice selection of by a single touch rather than slower textual input.

FIG. 3D illustrates a third menu for entering questions in accordance with an embodiment of the current invention. For example, when a user has chosen to enter questions interactively, he is queried whether he wants to record questions 358 (with audio and/or video input) or enter textual questions 360.

FIG. 3E illustrates a final menu for sharing an instructional bite in accordance with an embodiment of the current invention. Optionally, once an instructor finishes an instruction bite, the bite is stored on the server. In some embodiments, the instructor and/or an administrator is presented a menu for sharing the bite. For example, the instructor gives a name 364 to a group of learners who are to receive the lesson and/or populates the group with names. For example, the names may be from his contacts and/or from groups of contacts of an organization sponsoring the learning. Optionally, the instructor is given a menu 362 of social networks over which to share the bite. Optionally, when he chooses a network, he is moved to an interface of that network. For example, the network may facilitate sending a link to each member of the group defined inside and/or outside the network. For example, the students may be a group defined in the network. Alternatively or additionally, the sharing menu me part of the interface of the bite preparation interface. For example, links may be sent out from the server. Optionally a link is also sent to an overseer and/or a monitor of the lesson.

FIG. 4 illustrates method to present a lesson in accordance with an embodiment of the current invention. In some embodiments, a link is sent 412 to a learner for example over a social media. Optionally, the link connects the learner to a server wherein the instruction bit stored. Optionally, when the learner clicks the link is connected to a server which delivers 414 a portion (for example an introduction) of the bite to the device of the learner. In some embodiments, viewing a bite may be limited to certain users who must enter using a link. For example, the system may only make the bite available to registered devices and/or may require a password and/or confirmation over email, SMS etc. Optionally the server may track participation, time taken by the learner on lesson. For example, delivery 414 may not require downloading of a dedicated application. Optionally, the interface will collect auxiliary information, for example movement of the user device (for example using an accelerometer and/or GPS sensor of the device) and/or the background noise or light (for example using a camera and/or microphone of the device). For example, this may help track whether the learner is interrupting work to go over lessons, whether he is paying attention etc. For example, the bite may be delivered 414 in a standard format (e.g. HTML) for viewing using standard software (for example a web browser). Alternatively the learning may use a dedicated application and/or receive more advanced options when viewing and/or responding to the lesson. Optionally as a link is opening and/or as a user navigates through the various steps of an instructional bite, various monitoring databases are updating 413 making available to an instructor and/or a supervisor up to date information on the status of learning of the bite. Optionally, the system delivers 415 questions to the machine of the learner. Optionally questions are delivered 415 automatically after the learner has viewed introductory information and/or on demand and/or on demand only after the learner has viewed the introduction. In some embodiments, questions may be delivered 415 in the middle of viewing information, for example to make sure that the learner is really paying attention. In some embodiments, the interface receives 416 answers to questions from a learner. In some embodiments, a learner controls the pace on input and/or output of his lessons. Optionally answers may include a choice from a list of answers and/or a textual answer and/or a recorded answer (e.g. audio and/or video). and/or a visual answer (for example a still photograph and/or an image downloaded from the Internet). Optionally the interface grades the answers and/or presents 418 results to an instructor and/or or a supervisor and/or the learner. Alternatively or additionally, answers may be sent for manual graded for example by an instructor. Optionally the server may deliver 420 a closing and/or connect 424 the use to a discussion group. Connection 424 to the discussion may also include instructions and/or presentation of material to encourage and/or direct the discussion. Alternatively or additionally, a server may supply tools to a supervisor to mediate and/or monitor and/or control discussion.

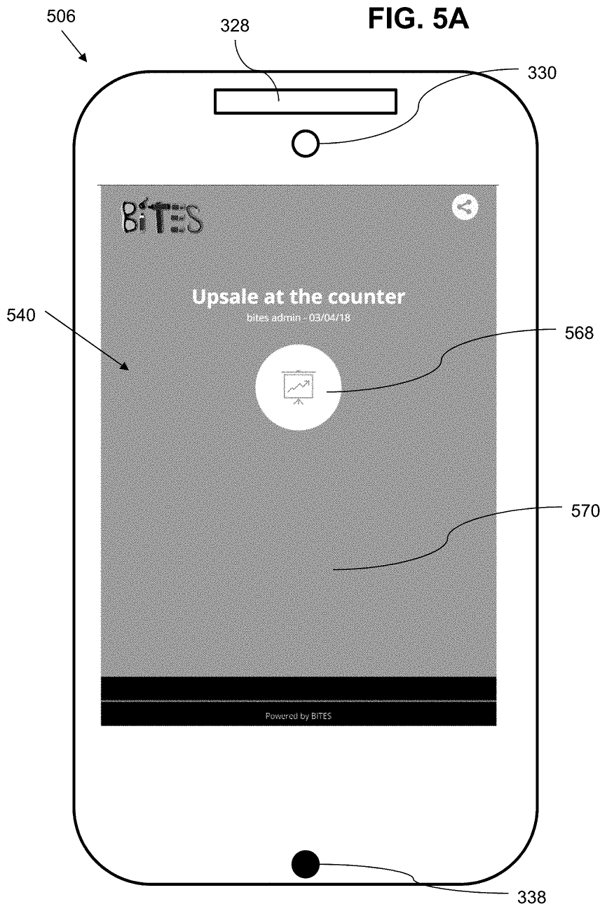

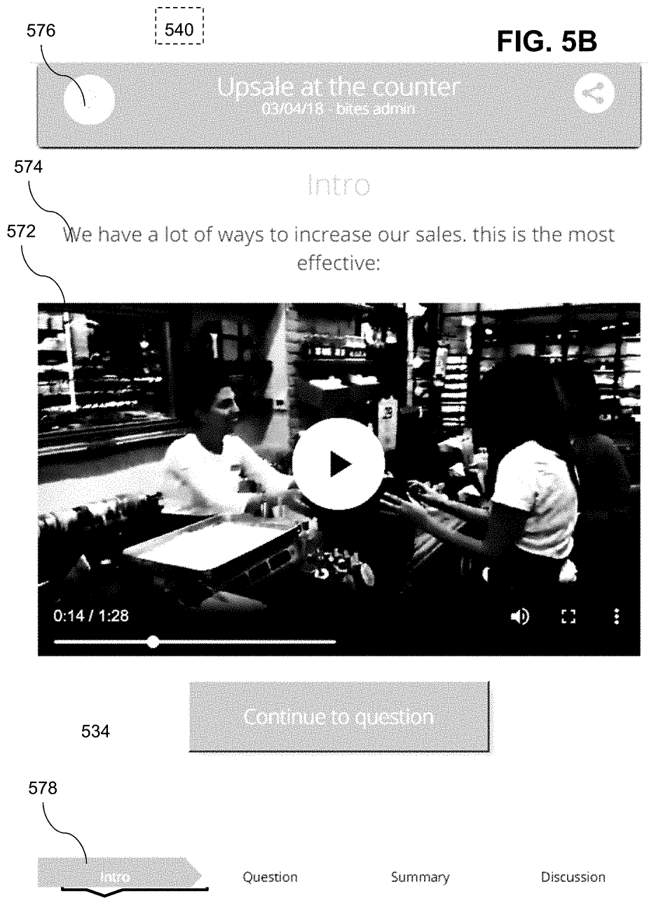

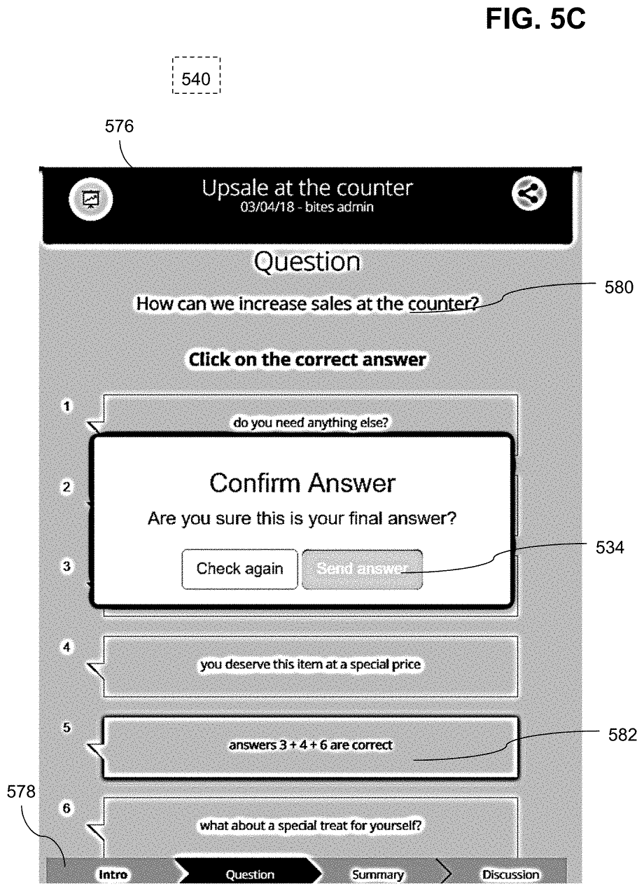

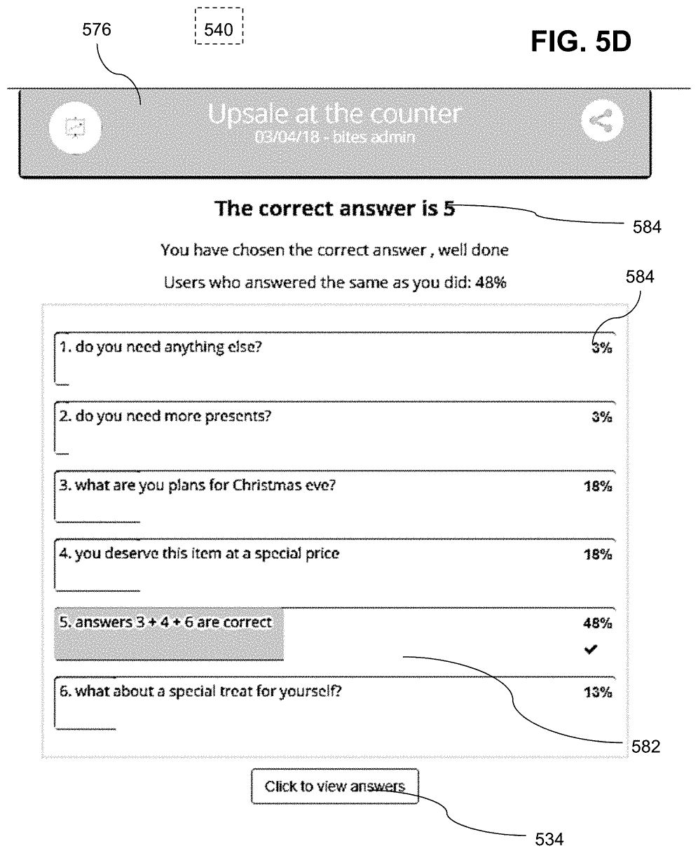

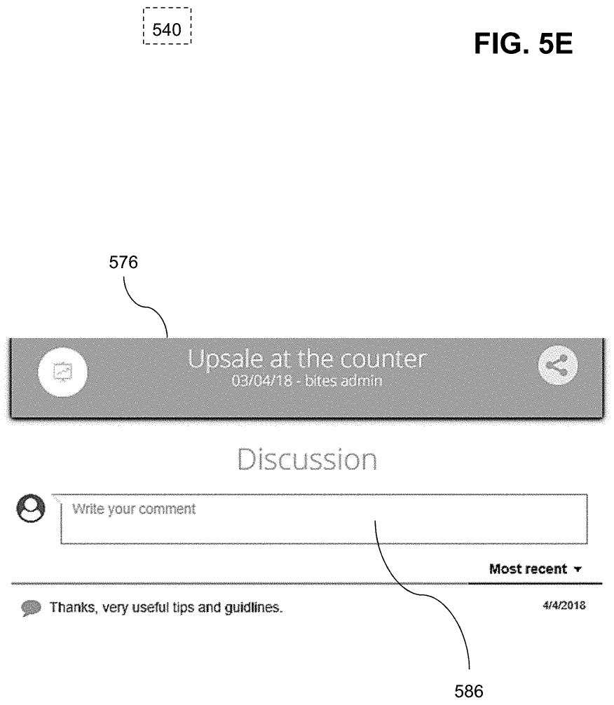

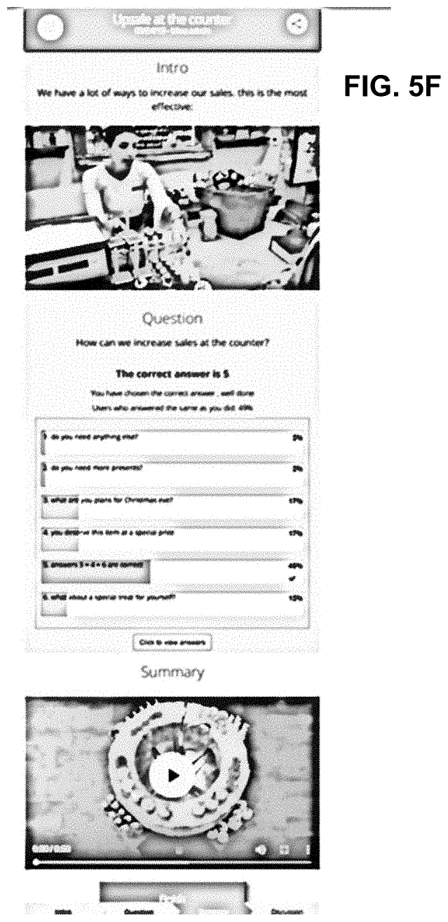

FIGS. 5A-5F illustrates method to produce and/or package and/or share a lesson in accordance with an embodiment of the current invention. In some embodiments a lesson is present on a user device 506 optionally including a touch screen 540 and/or other input or output devices, for example as described in the instructor device.

FIG. 5A is a screen shot illustration of an opening screen of an instructional bite in accordance with an embodiment of the current in invention. In some embodiments, the opening screen (e.g. cover) of the bite has a background 570 color and/or texture and/or the opening screen as a symbolic button 568 selected by the instructor. Optionally, the opening screen is simple, avoiding wasting taking up time making artistic statements. Optionally the color and/or symbol of the opening page are arranged as a memory aid for the learner to quickly find and/or recall a lesson and/or its contents.

FIG. 5B is a screen shot illustration of an introduction of a bite in accordance with an embodiment of the current invention. The FIG. shows an enlarged view touchscreen 540. Optionally, content is given over in the introduction through an educational video 572. For example, in an exemplary bite, a store manager of a chain store shares insights on at counter sales with the sales staff of a Northeastern region of the chain. For example, the manager makes a video 572 on his cell phone of his two members of his sales staff role modeling a cashier encouraging a customer to buy extra products at the checkout counter. Optionally, the introductory screen includes a title bar 576 which may include a title of the bite and/or may have a background matching the background color of the cover page and/or may include the bite symbol of the cover page. Optionally the introduction page includes a forward button 534 and/or a navigation menu 578. Optionally a lesson includes text and/or audio-visual material formatted for viewing on a mobile device.

FIG. 5C is a screen shot illustration of a question interface of a bite in accordance with an embodiment of the current invention. For example, a learner may be presented with a question 580 and/or a few choices for answers 582, for example in the form of buttons. Optionally when the learner chooses an answer, the answer is stored on his profile for example on a server and/or the bite moves to the next menu, for example a solution menu.

FIG. 5D illustrates a solution menu in accordance with an embodiment of the current invention. Optionally, the solution menu includes the correct answer 584 and/or an explanation of why one or more answer is correct and/or why one or more answers in incorrect. Optionally, a menu may include statistics about the learner and/or other learners in the group. For example, a solution page may include statistics 584 about how people answered the questions.

FIG. 5E illustrates a solution menu in accordance with an embodiment of the current invention. Optionally, a bite includes a discussion interface, for example facilitating further communication between the learners and the learners and the instructor of the material. For example, the discussion interface may include questions for discussion and/or links to games and/or links to cooperative learning activities to be performed over a network. Optionally or additionally, the discussion interface may include links to further resources in the server or over the network such as web sites with more information and/or forums related to the subject matter of the bite. Alternatively or additionally, the discussion interface includes a network chat window 586 for example allowing a student to send text, voice and/or video messages to members of the learning group. Optionally, use of the discussion page is monitored facilitating analysis of how much the students learned and/or how much interested was fostered and/or how much time was spent on the mobile device as a result of the bite.

FIG. 5F illustrates a screen shot of a scrolling page of a bite in accordance with an embodiment of the current invention. For example, a user may be able to page through the bite after he has learned the bite according to the order of presentation. Alternatively or additionally, various parts of the bite may be available to a user at other times during the lesson.

In some embodiments, a learner may download a complimentary student application and/or simply access the unit using a browser (as discussed above). Optionally, students may create unique usernames and/or passwords for the system (web or application based), and/or the system can be linked to an existing social network account such as Facebook® or Twitter®.

In some embodiments, the interface allows the user to view and/or interact with the system (e.g. play the video or audio clip and answer the questions). In some cases, the interface can facilitate a competitive element, pitting the students against each other for the best results. Optionally, an instructor driven forum can summarize the learning unit, ending off the multimedia package. The students can “chat” with each other and/or the instructor on the forum in order to clarify an issue or argue a point.

It is expected that during the life of a patent maturing from this application many relevant communication devices and/or networks will be developed and the scope of the terms are intended to include all such new technologies a priori.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. An interface for distributing an training content over a network comprising:
instructions stored on a computer readable medium accessible to a mobile device of an instructor for
packaging a training content item and at least one question into a lesson;
storing said lesson on a server connected over the network to a plurality of learner devices;
sending a link to said plurality of learner devices over a network for accessing said training content item from said server;
instructions stored on a computer readable medium accessible to said server for
sending said training content item to each learner device of said plurality of learner devices over the network in response to accessing said link by said each learner device and storing information about said sending;
further sending said at least one question to each learner device of said plurality of learner devices over the network on demand from said each learner device after said accessing said link by said each learner device and storing information about said further sending;
receiving a plurality of responses to said at least one question from said plurality of learner devices;
reporting said information on said sending and said information on said further sending and information of said plurality of responses to said instructor device over said network.

2. The interface of claim 1, further including a template stored on a computer readable medium accessible to said instructor device, said template including instructions for recording a narration for at least one of a picture and a video in said training content.

3. The interface of claim 2, where said interface includes instructions for limiting said narration to less than 2 minutes.

4. The interface of claim 2, wherein said narration is in audio format and said instructions of recording includes instructions for recording said narration over a microphone of said instructor device.

5. The interface of claim 2, wherein said narration is in a text format and said instructions of recording includes instructions for recording said narration using a textual input interface of said instructor device.

6. The interface of claim 1, wherein said interface further includes instructions for producing a group including said plurality of learner devices and said instructor device for discussion of said training content and for sharing said discussion with the group.

7. The interface of claim 6, wherein said sharing is over said network.

8. A method of distributing an training content item over a network comprising:
packaging a training content item and at least one question into a lesson;
storing said lesson on a server connected over the network to a plurality of learner devices;
sending a link to said plurality of learner devices over a network for accessing said training content item from said server;
sending said training content item to each learner device of said plurality of learner devices over the network in response to accessing said link by said each learner device and storing information about said sending;
further sending said at least one question to each learner device of said plurality of learner devices over the network on demand from said each learner device after said accessing said link by said each learner device and storing information about said further sending;
receiving a plurality of responses to said at least one question from said plurality of learner devices; and
reporting said information on said sending and said information on said further sending and information of said plurality of responses to an instructor device over said network.

9. The method of claim 8, further including recording a narration for at least one of a picture and a video in said training content.

10. A system for overseeing distribution of a teaching content over a network:
a plurality of learner devices connected to the network;
a server connected to the network, the server including
a memory for storing a packaged lesson, distribution information and response data;
a processor configured for
sending a training content item to each learner device of said plurality of learner devices over the network in response to accessing a link by said each learner device and storing information about said sending;
further sending at least one question to each learner device of said plurality of learner devices over the network on demand from said each learner device after said accessing said link by said each learner device and storing information about said further sending;
receiving a plurality of responses to said at least one question from said plurality of learner devices;
reporting said information on said sending and said information on said further sending and information of said plurality of responses to an instructor device over said network;
an instructor device configured for,
packaging said training content item and said at least one question into a lesson;
storing said lesson on a server connected over the network to a plurality of learner devices;
sending a link to said plurality of learner devices over a network for accessing said training content item from said server.

11. The system of claim 10, further including a template stored on a computer readable medium accessible to said instructor device, said template including instructions for recording said at least one question in audio format using a microphone of said instructor device.

12. The system of claim 10, further including a template stored on a computer readable medium accessible to said instructor device, said template including instructions for recording a narration for at least one of a picture and a video in said training content.

13. The system of claim 12, where said system includes instructions for limiting said narration to less than 2 minutes.

14. The system of claim 12, wherein said narration is in audio format and said instructions of recording includes instructions for recording said narration over a microphone of said instructor device.

15. The system of claim 12, wherein said narration is in a text format and said instructions of recording includes instructions for recording said narration using a textual input interface of said instructor device.

16. The system of claim 10, wherein said system further includes instructions for producing a group including said plurality of learner devices and said instructor device for discussion of said training content and for sharing said discussion with the group.

17. The system of claim 16, wherein said sharing is over said network.

18. The system of claim 16, wherein said system further includes instructions to include a mediator in said group.

19. The system of claim 10, wherein said training content includes an introduction and a closing and further including a template stored on a computer readable medium accessible to said instructor device, said template including instructions for preparing a structured lesson having four portions consisting of said introduction, said closing, said at least one questions and said discussion and wherein said instructions include a limitation to a length of said introduction, said closing and said at least one question.
